(19) United States
(12) Patent Application Publication
(10) Pub. No.: US 2020/0147864 A1
(43) Pub. Date: May 14, 2020

(54) ADDITIVE MANUFACTURING

(71) Applicant: OPEN BIONICS LTD, Bristol (GB)

(72) Inventor: Steve Wood, Swindon (GB)

(21) Appl. No.: 16/676,950

(22) Filed: Nov. 7, 2019

(30) Foreign Application Priority Data
Nov. 8, 2018 (GB) 1818229.5

(51) Int. Cl. B29C 64/118; B29C 64/209

(52) U.S. Cl. CPC B29C 64/118; B29L 2023/22; B29C 64/209

(57) ABSTRACT

A method of fused deposition modelling manufacture of a generally cylindrical, hollow object is provided. The method includes a plurality of Travel Move steps, in which each Travel Move step is constrained to follow a travel path that does not pass through an inside region of the object.

### CROSS-REFERENCE TO RELATED APPLICATION(S)

This United States Non-Provisional Patent Application relies for priority on United Kingdom Patent Application No. GB 1818229.5, filed on Nov. 8, 2018, the entire content of which is incorporated herein by reference.

### FIELD OF THE INVENTION

The present invention relates generally to additive manufacturing methods and particularly, although not exclusively, to 3D printing and products arising therefrom.

### DESCRIPTION OF THE RELATED ART

Fused deposition modelling (FDM), for example, is a type of 3D printing where a printer extrudes a filament, building objects up in layers. The tool head on a 3D printer is known as an extruder; it consists of a heater and a nozzle. The filament is pushed through the extruder as the machine prints.

During an FDM print the extruder must sometimes stop extruding and move to another point on the model. For example, the printer will complete a layer, then stop extruding and move to the start point of the next layer before resuming extrusion. This is known as a Travel Move.

The problem with Travel Moves is that although the printer is not extruding, small amounts of material can ooze from the nozzle. This is especially likely to happen at the start of a Travel Move as the nozzle is pulled away from the part; the molten material still connected to the part is drawn out by surface tension producing “whisps” or “bobbles” on the surface of the part. It can also happen at the end of a travel move; any material that has oozed out of the nozzle over the travel is deposited onto the part as the nozzle reaches it.

It is possible to reduce these effects by tuning the printer's settings. However, it is difficult to reliably eliminate them. On a typical print, there will be many hundreds of Travel Moves, so it is likely there will be a few artefacts left on the surface of the part.

FIG. 1, for example, illustrates a generally cylindrical part formed by an FDM print and shown with an internal Travel Move and an excess material line/artefact, which could in some ways be likened to flashing or a witness mark in a moulding process.

This type of unwanted surface material is problematic for certain types of application. For example, where products that come into contact with a person can have particular requirements.

### SUMMARY OF THE INVENTION

The present invention addresses one or more of the deficiencies known to persist in the prior art.

In one non-limiting embodiment, the present invention provides a method of fused deposition modelling manufacture of a generally cylindrical, hollow object, the method comprising a plurality of Travel Move steps, in which each Travel Move step is constrained to follow a travel path that does not pass through an inside region of the object.

In one other embodiment of the method, the travel path between the travel start and travel end is a generally arcuate path around the object.

According to another embodiment of the method, a centre position and a diameter of a circle that all Travel Moves will move around is chosen such that the circle is approximately centred on the object and of a diameter large to encompass the whole part.

For the method, it is contemplated that each travel path is created such that the printer nozzle moves radially out to the circle, around the circle, then radially inwards to the end point of the travel.

In still another embodiment of the method, the travel path is chosen to minimise the length of travel.

Separately, the method may be organized where there is a threshold for the distance between the start and end points.

In one contemplated embodiment, the method further includes a method of fused deposition modelling manufacture of a prosthetic limb socket, the method including a plurality of point to point printer nozzle Travel Moves, in which the nozzle is prevented from travelling through the inside region of the socket, whereby unwanted ooze of material from the nozzle is deposited only on the outside of the socket.

For this method, the nozzle is contemplated to follow a generally circular travel path around the socket during Travel Moves.

The present invention also provides a method of 3D printing a generally tubular object. The method includes a plurality of Travel Move steps, in which all or the majority of the Travel Move steps are constrained to follow a travel path that does not pass across the lumen of the object.

It is contemplated that the method may include a method of fused deposition modelling manufacture of an object, the method comprising a plurality of Travel Move steps, in which each Travel Move step is constrained to follow a travel path that does not pass through an inside region of the object.

Still further, the method may include a method of fused deposition modelling manufacture of a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer. If so, the wearable part is contemplated to be generally cylindrical.

The present invention also encompasses a method of additive manufacturing a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer.

Here, the method includes fused deposition modelling manufacture.

In addition, in the method, each Travel Move step may be constrained to follow a travel path that passes only outboard of the part.

The method contemplates that the part is generally cylindrical.

The method also contemplates that the wearable part may be or may form part of a prosthetic

In one contemplated embodiment, the wearable part, is a prosthetic arm socket or liner.

### BRIEF DESCRIPTION OF THE DRAWINGS

The present invention will now be described in connection with the drawings in which:

FIG. 1 illustrates a generally cylindrical part formed by an FDM print and shown with an internal Travel Move and an excess material line/artefact;

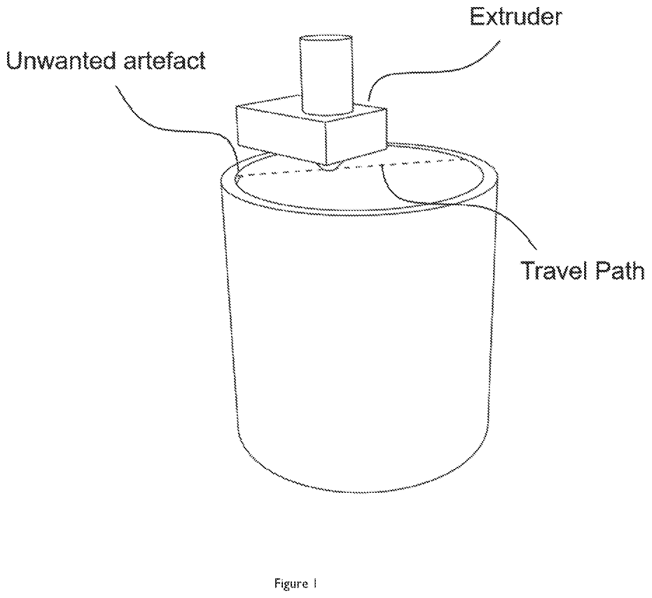

FIG. 2 illustrates a prosthetic arm that includes a socket/liner printed in the semi-flexible Cheetah plastic from Fenner Drives which is a certified medical safe material to ISO 10993, tested by Envigo Laboratory;

FIG. 3 illustrates a prosthetic arm socket, shown in the usual print orientation (vertical with elbow at the top);

FIG. 4 shows a typical Travel Move on the socket, shown mid-print; and

FIG. 5 shows the same point to point Travel Move as FIG. 4, but follows a circular path around the object.

### BRIEF DESCRIPTION OF EMBODIMENT(S) OF THE INVENTION

An aspect of the present invention provides a method of fused deposition modelling manufacture of a generally cylindrical, hollow object, the method comprising a plurality of Travel Move steps, in which each Travel Move step is constrained to follow a travel path that does not pass through an inside region of the object.

An aspect of the present invention provides a method of 3D printing a generally tubular object, the method comprising a plurality of Travel Move steps, in which all or the majority of the Travel Move steps are constrained to follow a travel path that does not pass across the lumen of the object.

The travel path between the travel start and travel end may be a generally arcuate path around the object.

The travel start may begin with a radially outward component of movement and the travel end may finish with a radially inward component of movement.

In some embodiments a centre position and a diameter of a circle that all Travel Moves will move around is chosen such that the circle is approximately centred on the object and of a diameter large enough to encompass the whole part.

Each travel path may be created such that the printer nozzle moves radially out to the circle, around the circle, then radially inwards to the end point of the travel.

The travel path may be chosen to minimise the length of travel.

In some embodiments there is a threshold for the distance between the start and end points.

The present invention also provides a method of fused deposition modelling manufacture of a prosthetic limb socket, the method including a plurality of point to point printer nozzle Travel Moves, in which the nozzle is prevented from travelling through the inside region of the socket, whereby unwanted ooze of material from the nozzle is deposited only on the outside of the socket.

The nozzle may follow a generally circular travel path around the socket during Travel Moves. Other aspects and embodiments are not limited to circular paths.

The present invention also provides objects, such as prosthetic limb sockets, formed by methods described or contemplated herein.

In some aspects and embodiments the present invention is deployed not to reduce and/or hide “detects” but rather as an attempt to control where they are. The present invention may not be concerned with the starting and/or finishing of a layer, but rather with travel moves.

Some aspects and embodiments relate to a wearable printed part e.g. a part that may, in use, be in contact with a wearer.

The present invention also provides a method of fused deposition modelling manufacture of an object, the method comprising a plurality of Travel Move steps, in which each Travel Move step is constrained to follow a travel path that does not pass through an inside region of the object.

The present invention also provides a method of fused deposition modelling manufacture of a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer.

The wearable part may be generally cylindrical.

The present invention also provides a method of additive manufacturing a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer.

The present invention also provides a method of fused deposition modelling manufacture of a hollow object, the method comprising a plurality of Travel Move steps, in which each Travel Move step is constrained to follow a travel path that passes only outboard of the object.

The object may be generally cylindrical. The object may, for example, be a wearable part, such as one in which an internal surface is intended to be in contact with a wearer in use.

One embodiment of the present invention relates to a prosthetic arm that includes a socket/liner, for example printed in the semi-flexible Cheetah plastic from Fenner Drives which is a certified medical safe material to ISO 10993, tested by Envigo Laboratory.

Due to the generally cylindrical shape, almost every Travel Move would leave artefacts on the surface that contacts the wearer's skin. Artefacts are likely to form at the start and end of path. Even the smallest artefact will harden as the part cools and if it is on the internal surface of the socket will cause discomfort to the wearer. The present invention seeks to address this problem by preventing the nozzle from travelling through the inside region of the wearable part (such as a socket). An embodiment may use the same point to point Travel Move but following a circular path around the object. Using this path, the artefact is left on the outside of the part where it won't affect the user and is more easily removed.

### Example Method of Operation

“Slicing” software such as “Cura” or “Simplify3D” is used to convert a 3D model into a series of instructions for a printer. Modifying how this software goes about planning travel moves would be complex and specific to each one. While this method could be implemented, a simpler method may be used in some embodiments.

A mock example of the output of this software, “GCODE”, is given below:

F2600
G1 X10 Y10 Z10 E20

The first line tells the printer to move at a speed of 2600 millimetres per minute. The second, that it should move to X=10 mm, Y=10 mm, Z=10 mm while extruding 20 mm of filament. This implementation works by running a post-processing script on the GCODE output of the slicing software. This is accomplished by leveraging the fact that printers move faster during Travel Moves. The script scans the document for the points where the speed is set to the Travel Move speed in a similar manner to the first line in the example. It then checks to see where travel moves end by scanning for where the speed is set to one of the speeds used in printing. The start and end points of the travel can be determined by looking at the XYZ coordinates on the lines immediately before the changes in speed. Any lines between the start and end points of travel moves are then replaced with the newly generated travel path.

### Generating Circular Travel Paths

The two inputs to the post-processing script are the centre position and diameter of the circle that all the Travel Moves will move around. It is chosen such that the circle is approximately centred on the part and of a diameter large to encompass the whole part. Each travel path is then created such that the nozzle moves radially out to circle, around the circle, then radially inwards to the end point of the travel. Whether the nozzle moves clockwise or anti-clockwise is chosen to minimise the length of travel. For example, the nozzle will move 90° anticlockwise rather than 270° clockwise. There is also a threshold for the distance between the start and end points. If the distance is too small, the script will not replace the travel. This is to prevent forcing the nozzle to move out to the circle and back when the original Travel Move was not oozing enough to cause a problem.

Different aspects and embodiments of the invention may be used separately or together.

The present invention is more particularly described, by way of example, with reference to the accompanying drawings.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

One example of a work product to which the present invention may be applicable is in the field of prosthetic limbs.

A prosthesis is an artificial device that replaces a missing body part, which may be lost through trauma, disease, or congenital conditions. Prostheses are intended to restore the normal functions of the missing body part.

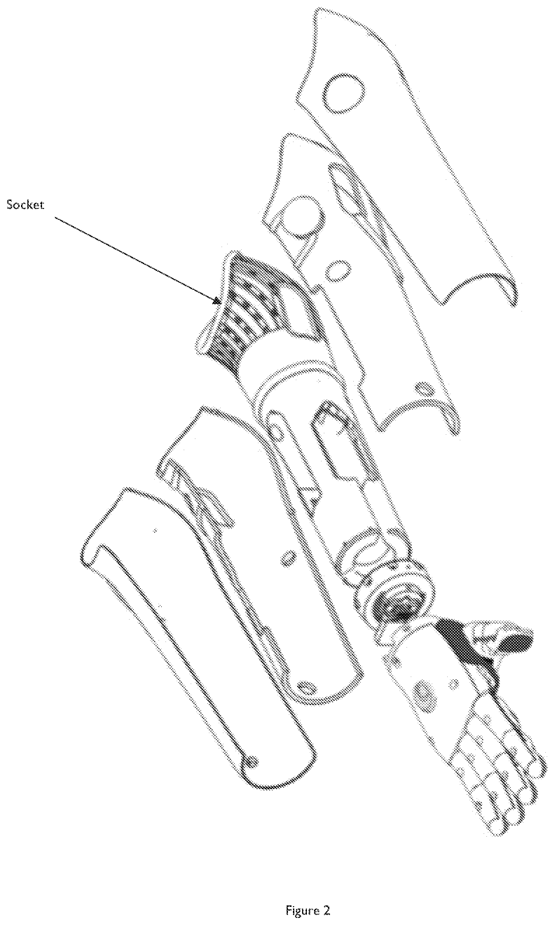

FIG. 2 illustrates a prosthetic arm that includes a socket/liner, for example printed in the semi-flexible Cheetah plastic from Fenner Drives which is a certified medical safe material to ISO 10993, tested by Envigo Laboratory.

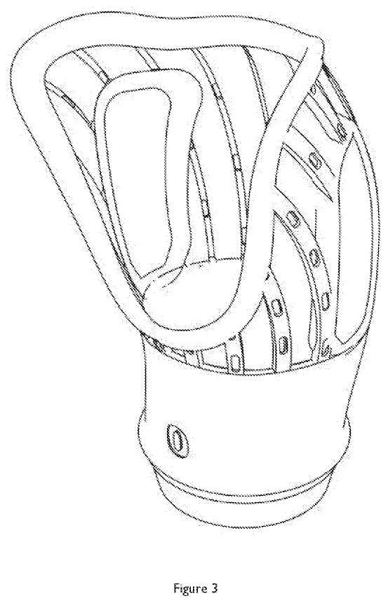

FIG. 3 illustrates a prosthetic arm socket, shown in the usual print orientation (vertical with elbow at the top).

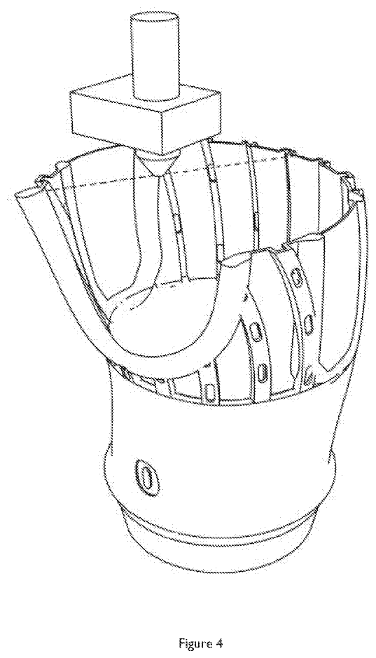

FIG. 4 shows a typical Travel Move on the socket of FIG. 4 shown mid-print. The Travel Path of the Extruder is shown as a dashed line. Due to the generally cylindrical shape, almost every Travel Move will leave artefacts on the surface that contacts the wearer's skin. Artefacts are likely to form at the start and end of the dashed line. Even the smallest artefact will harden as the part cools and if it is on the internal surface of the socket will cause discomfort to the wearer.

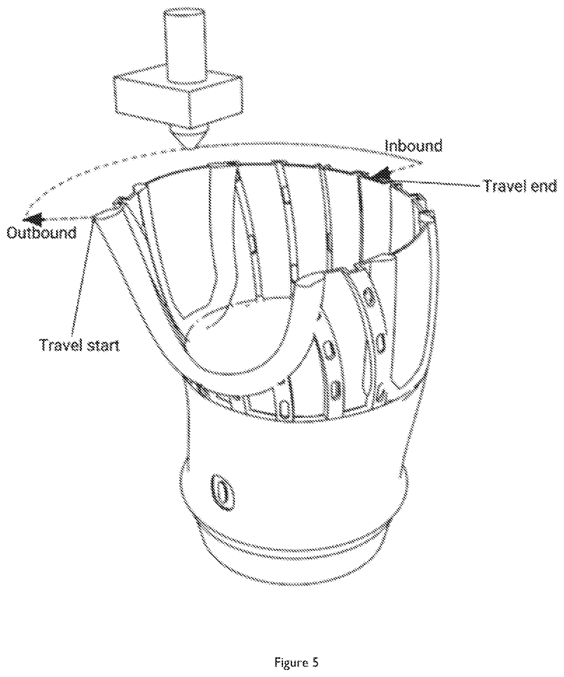

The present invention seeks to address this problem by preventing the nozzle from travelling through the inside region of the socket. The principle is illustrated in FIG. 5, which shows the same point to point Travel Move as FIG. 4, but following a circular path around the object.

Using this path, the artefact is left on the outside of the part e it won't affect the user and is more easily removed.

### Example Method of Operation

“Slicing” software such as “Cura” or “Simplify3D” is used to convert a 3D model into a series of instructions for a printer. Modifying how this software goes about planning travel moves would be complex and specific to each one. While this method could be implemented, a simpler method may be used in some embodiments.

A mock example of the output of this software, “GCODE”, is given below:

F2600
G1 X10 Y10 Z10 E20

The first line tells the printer to move at a speed of 2600 millimetres per minute. The second, that it should move to X=10 mm, Y=10 mm, Z=10 mm while extruding 20 mm of filament. This implementation works by running a post-processing script on the GCODE output of the slicing software. This is accomplished by leveraging the fact that printers move faster during Travel Moves. The script scans the document for the points where the speed is set to the Travel Move speed in a similar manner to the first line in the example. It then checks to see where travel moves end by scanning for where the speed is set to one of the speeds used in printing. The start and end points of the travel can be determined by looking at the XYZ coordinates on the lines immediately before the changes in speed. Any lines between the start and end points of travel moves are then replaced with the newly generated travel path.

### Generating Circular Travel Paths

The two inputs to the post-processing script are the centre position and diameter of the circle that all the Travel Moves will move around. It is chosen such that the circle is approximately centred on the part and of a diameter large to encompass the whole part. Each travel path is then created such that the nozzle moves radially out to circle, around the circle, then radially inwards to the end point of the travel. This is shown in FIG. 5. Whether the nozzle moves clockwise or anti-clockwise is chosen to minimise the length of travel. For example, the nozzle will move 90° anticlockwise rather than 270° clockwise. There is also a threshold for the distance between the start and end points. If the distance is too small, the script will not replace the travel. This is to prevent forcing the nozzle to move out to the circle and back when the original Travel Move was not oozing enough to cause a problem.

Although an illustrative embodiment of the invention has been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. A method of fused deposition modelling manufacture of a generally cylindrical, hollow object, the method comprising a plurality of travel move steps, in which each travel move step is constrained to follow a travel path that does not pass through an inside region of the object.

2. A method according to claim 1, in which the travel path between the travel start and travel end is a generally arcuate path around the object.

3. A method according to claim 1, in which a centre position and a diameter of a circle that all Travel Moves will move around is chosen such that the circle is approximately centred on the object and of a diameter large to encompass the whole part.

4. A method according to claim 3, in which each travel path is created such that the printer nozzle moves radially out to the circle, around the circle, then radially inwards to the end point of the travel.

5. A method according to claim 1, in which the travel path is chosen to minimise the length of travel.

6. A method according to claim 1, in which there is a threshold for the distance between the start and end points.

7. A method according to claim 1, comprising a method of fused deposition modelling manufacture of a prosthetic limb socket, the method including a plurality of point to point printer nozzle Travel Moves, in which the nozzle is prevented from travelling through the inside region of the socket, whereby unwanted ooze of material from the nozzle is deposited only on the outside of the socket.

8. A method according to claim 7, in which the nozzle follows a generally circular travel path around the socket during Travel Moves.

9. A method of 3D printing a generally tubular object, the method comprising a plurality of Travel Move steps, in which all or the majority of the Travel Move steps are constrained to follow a travel path that does not pass across the lumen of the object.

10. A method according to claim 1, comprising a method of fused deposition modelling manufacture of an object, the method comprising a plurality of Travel Move steps, in which each Travel Move step is constrained to follow a travel path that does not pass through an inside region of the object.

11. A method according to claim 1, comprising a method of fused deposition modelling manufacture of a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer.

12. A method according to claim 11, in which the wearable part is generally cylindrical.

13. A method of additive manufacturing a wearable part, the method comprising a plurality of Travel Move steps, in which each Travel Move step is constrained to follow a travel path that does not pass through an inside region of the part, whereby artefacts formed as a consequence of the Travel Move steps are restricted to surfaces which are not in contact with a wearer.

14. A method according to claim 13, comprising of fused deposition modelling manufacture.

15. A method according to claim 13, in which each Travel Move step is constrained to follow a travel path that passes only outboard of the part.

16. A method as claimed in claim 13, in which the part is generally cylindrical.

17. A method as claimed in claim 13, in which the wearable part is or forms part of a prosthetic limb.

18. A method according to claim 17, in which the wearable part is a prosthetic arm socket or liner.
